(19) United States
(12) Patent Application Publication
(10) Pub. No.: US 2021/0307425 A1
(43) Pub. Date: Oct. 7, 2021

(54) Face shield

(71) Applicant: Hans Keim Kunststoffe GmbH, Zimmern ob Rottweil (DE)

(72) Inventor: Christoph M. Keim, Leonberg (DE)

(73) Assignee: Hans Keim Kunststoffe GmbH, Zimmern ob Rottweil (DE)

(21) Appl. No.: 16/935,472

(22) Filed: Jul. 22, 2020

Related U.S. Application Data
(63) Continuation-in-part of application No. 29/738,343, filed on Jun. 17, 2020.

(30) Foreign Application Priority Data
Apr. 7, 2020 (DE) 402020100353.0

(51) Int. Cl. A41D 13/11; A42B 1/24; A41D 31/10

(52) U.S. Cl. CPC A41D 13/1184; A41D 13/1107; A41D 2500/52; A41D 31/10; A42B 1/24

(57) ABSTRACT

A method for producing a face shield includes cutting a body of the face shield from a flat sheet of transparent plastic and cutting a curved attachment slot into the body. It includes placing the body onto a horizontally arranged elongated convex mold with a central axis of the body being aligned with a ridge line of the mold and placing the body, on the mold, into an oven. There, the body deforms and assumes an arcuate shape of the mold. The body is allowed to cool down and later removed from the mold. The face shield has a body with an arcuate vertical cross-sectional shape which is smooth without edges. The curved attachment slot serves to attach the face shield to a visor of a baseball cap where it can hold on by a plurality of narrowings formed in the attachment slot.

### TECHNICAL FIELD

The present disclosure relates to a face shield made of transparent plastic suitable for attachment to a baseball cap.

### BACKGROUND

Face shields are known to protect a wearer from injury, serving as a substitute of safety goggles. They are suitable to reduce a range of droplets expelled by a user and may help protect a user from droplets expelled by others.

### SUMMARY

A method for producing a face shield includes cutting a body of the face shield from a flat sheet of transparent plastic and cutting a curved attachment slot into the body. The body is placed onto a horizontally arranged elongated convex mold with a central axis of the body being aligned with a ridge line of the mold. The body, on the mold, is placed into an oven. There, the body deforms and assumes an arcuate shape of the mold. The body and the mold are removed from the oven and the body is allowed to cool down. Lastly, the body is removed from the mold.

Preferably, the arcuate shape of the mold is free of edges. The transparent plastic may polyethylene terephthalate glycol (PETG).

Cutting the body and cutting the curved attachment slot may be performed by a laser. Cutting the curved attachment slot into the body may include forming a plurality of narrowing protrusions within the curved attachment slot. The plurality of narrowing protrusions may include a central protrusion arranged in the central axis of the face shield which can be used to for aligning the face shield with a ridge line marking of the mold.

The oven may use infrared light sources causing the body to deform by activating the infrared light sources. The mold may be covered with a textile material.

A face shield that can be produced according to the described method has a body made of transparent plastic. The body has an arcuate vertical cross-sectional shape which is smooth without edges. The body includes a curved attachment slot for attaching the face shield to a visor of a baseball cap, the curved attachment slot having portions of constant width separated by a plurality of narrowings. The curved attachment slot extends vertically between an upper edge and a lower edge. The narrowings may be formed by protrusions alternatingly extending from the upper edge and the lower edge along a width of the curved attachment slot. The protrusions may have a generally triangular shape with a pointed tip arranged within the curved attachment slot.

The narrowings may have a height between 10% and 50% of the constant width. A cross-sectional shape of the body may be generally a semi-circle. The face shield may be made of polyethylene terephthalate glycol (PETG). The body may have a height between 18 cm and 20 cm and a thickness between 0.7 mm and 1.0 mm. The body may have a lower symmetry mark in a central axis.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows a face shield attached to a visor of a baseball cap.

FIG. 2 is a perspective view of a face shield.

FIG. 3 is a front view of the face shield as in FIG. 2.

FIG. 4 is a side view of the face shield as in FIG. 2.

FIG. 5 is a top view of the face shield as in FIG. 2.

FIG. 6 is a schematic illustration of a manufacturing process of a face shield.

FIG. 7 is a photograph showing the spread of droplets expelled by a user wearing a face shield after 75 milliseconds.

FIG. 8 is a photograph as in FIG. 8 after 200 milliseconds.

### DETAILED DESCRIPTION

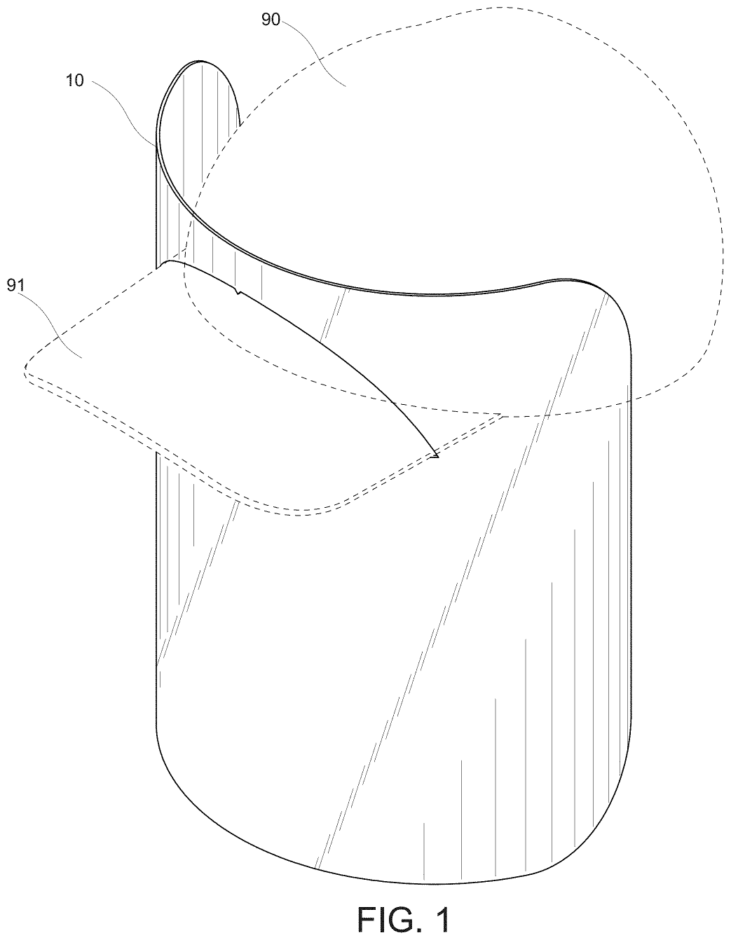

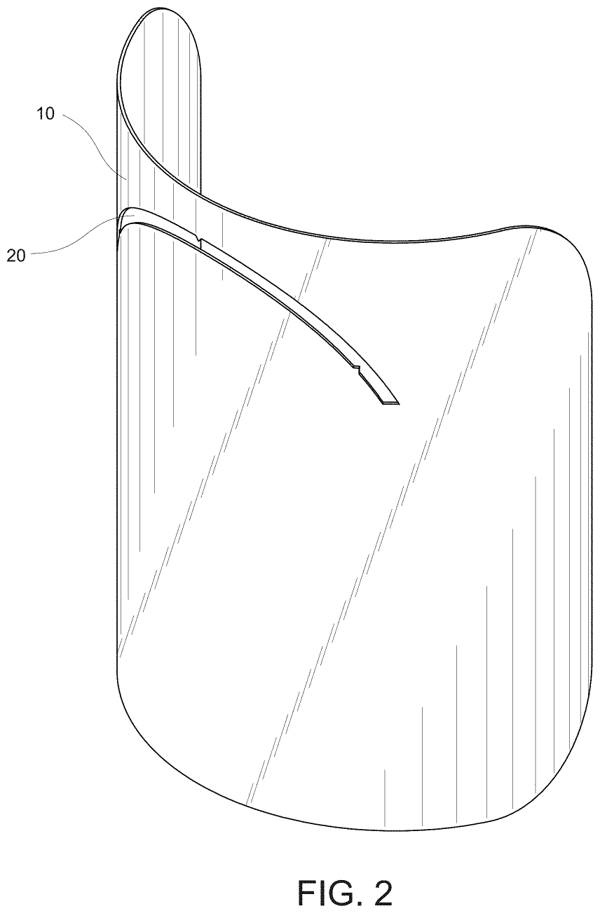

Referring to FIG. 1, a face shield is shown attached to a visor 91 of a baseball cap 90. The face shield includes a body 10 made of transparent plastic. Polyethylene terephthalate glycol (PETG), a glycol modified version of polyethylene terephthalate (PET), is a preferred such transparent plastic.

The body 10 has an arcuate vertical cross-sectional shape which is smooth without edges. The cross-sectional shape of the body 10 is pre-formed and consistent along a longitudinal axis 11 of the body 10. That is, the shield body 10 is not bent into an arcuate shape by an end-user but manufactured to have a pre-formed and consistently curved cross section.

To maintain its desired shape, the body 10 has a thickness of 0.75 mm to 1.00 mm. Use of thinner materials is not desirable, as they are unable to maintain the desired pre-formed shape and tend to have sharp edges. Using a body with a thickness greater than 1.00 mm leads to an increased and undesirably large weight of the shield.

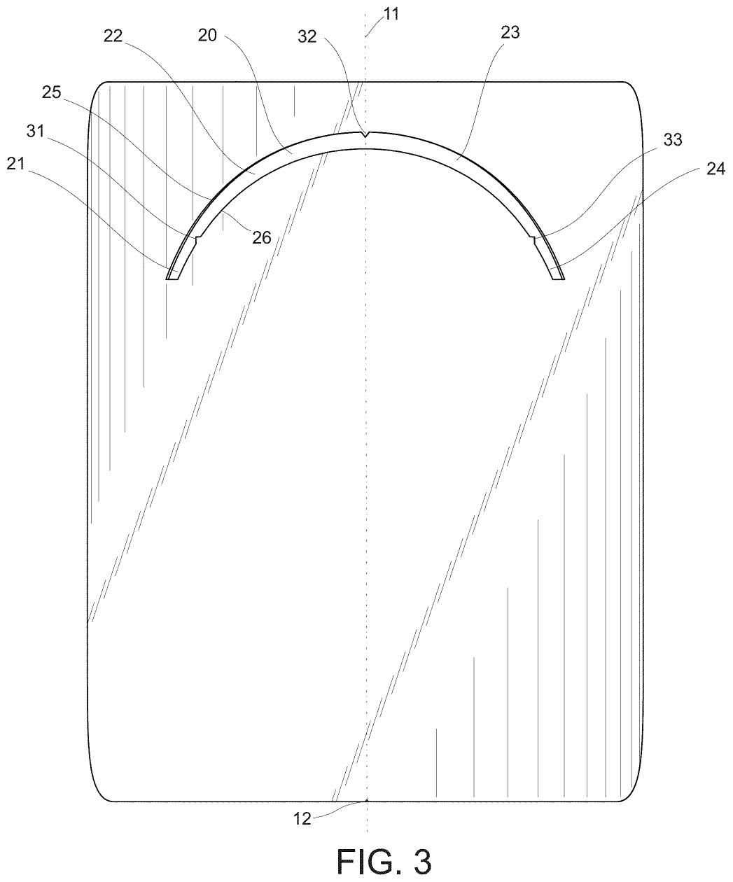

As shown in FIG. 3, a curved attachment slot 20 for attaching the face shield to the visor 91 of the baseball cap 90 is laterally centered in an upper portion of the body 10. The curved attachment slot 20 has portions of constant width 21, 22, 23, 24 separated by a plurality of narrowing protrusion 31, 32, 33.

The curved attachment slot extends vertically between an upper edge 25 and a lower edge 26. The narrowing protrusions 31, 32, 33 are formed by protrusions alternatingly extending from the upper edge 25 and the lower edge 26 along a width of the slot. The protrusions have a generally triangular shape with a pointed tip arranged within the slot 20. As shown in FIG. 3, a central protrusion 32 is arranged within the center axis 11 of the body 10. The body 10 is symmetrical about the center axis 11. An inconspicuous lower symmetry mark 12 may be formed in a lower portion of the body in the center axis 11.

The narrowing protrusions 31, 32, 33 have a height between 10% and 50% of the constant width of the attachment slot 20. That is, between its portions of constant width 21, 22, 23, 24 the attachment slot 20 may be narrowed to 50% to 90% of its otherwise constant width.

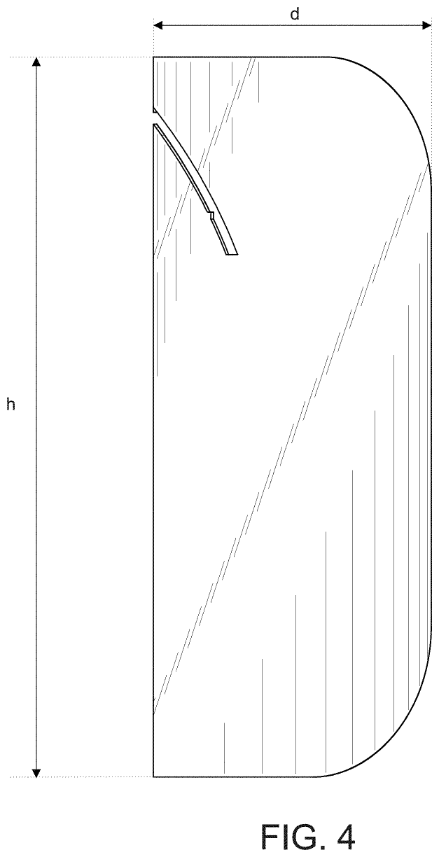

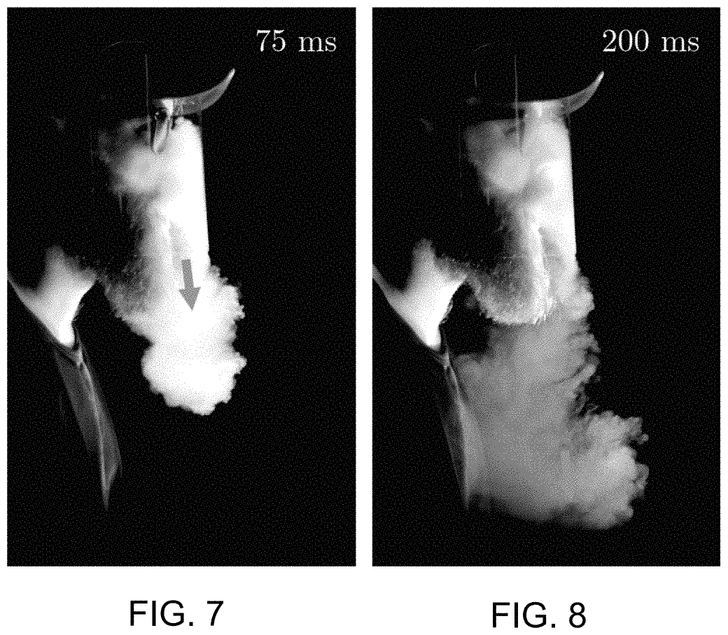

Referring to FIG. 4, the shield body 10 has a height h between 19 and 22 cm. The use of shield bodies having a height between 20 cm and 21 cm has proven effective in preventing the spread of droplets as illustrated in simulated coughing experiments illustrated in FIG. 7 and FIG. 8. Experiments also showed that the pre-formed arcuate shape of the body 10 which extends below the chin of a user and reaches around parts of the user's neck is effective both in preventing the spread of droplets from the user to others and in reducing the exposure of a user to droplets expelled by others.

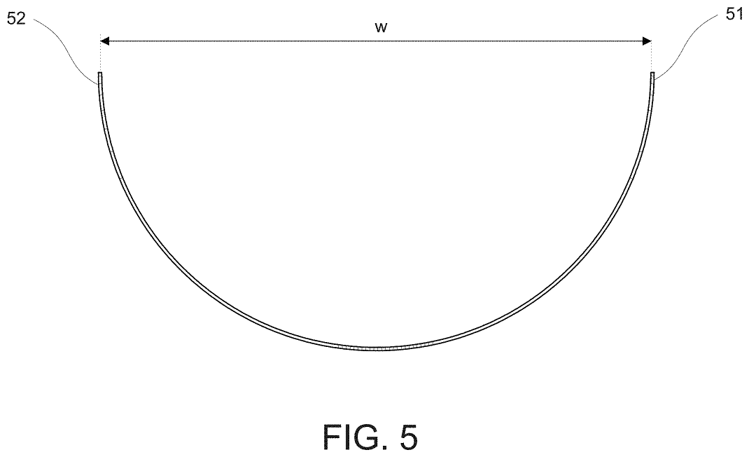

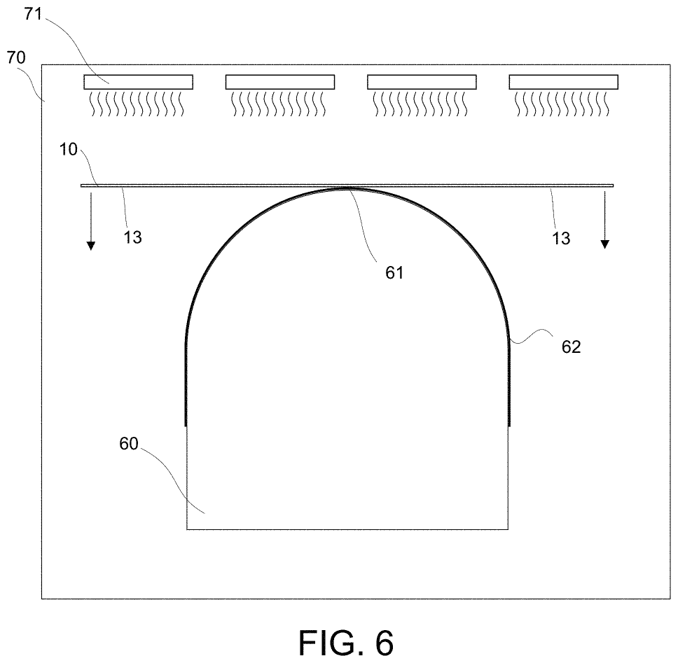

As shown in FIG. 5, the shield body has a cross-sectional shape which is approximately a semi-circle having a width w of the shield body between 18 and 20 cm, preferably 19 cm. The generally semi-circular shape is smooth without any edges. The bending radius of the shield body 10 from its left lateral edge 51 to its right lateral edge 52 is nearly constant. This shape creates superior optical characteristics and minimizes any visually undesirable artefacts a user of the shield might otherwise observe. An arc-length of the shield along its lateral extension is about 32 cm.

The face shield is manufactured according to a unique method. The raw material used for manufacturing the face shield are flat sheets of PETG having dimensions of about 2×3 m and a thickness of 1 mm or 0.75 mm. The body 10 of the face shield is cut from the raw material sheet. While PETG is often cut with a milling tool, the use of a laser for cutting is preferred as it leads to smoother edges. With the same laser the curved attachment slot is cut into the body.

The cut-out body 10 is removed from the original flat sheet and any burrs that may have formed during the cutting process are removed, for example by sliding a sharp knife along the perimeter of the body 10.

The body 10 is then placed onto a horizontally arranged elongated convex mold 60. The body 10 is aligned such that its center axis 11 aligns with a ridge line 61 of the mold 60. This alignment is supported by a ridge line marking on the mold 60. The body 10 is placed onto the mold 60 such that the central protrusion 32 and the lower symmetry mark 12 are aligned with the ridge line marking.

The body 10, balanced on top of the mold 60, is then placed into an infrared oven 70. The mold 60 may accommodate more than one body 10, and several molds 60 may be arranged on a rolling cart. The rolling cart may be used to move the mold and the body into and out of the oven 70. The infrared oven 70 includes one or more infrared light sources 71 arranged above the body 10 and the mold 60. The infrared light sources 71 are powered for approximately 20 sec, heating the body 10 to a temperature which allows the thermoplastic PETG to bend under its own weight. Side portions 13 of the body 10 bend downward under their own weight and wrap around the mold 60. The mold 60 is preferably covered with a textile surface 62 to prevent the softened PETG body 10 to stick to the mold 60. The textile surface 62 may be a microfiber cloth.

The body 10 and the mold 60 are removed from the oven and the body 10 is allowed to cool down. The cooled body 10 is later removed from the mold 60.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

The words “example” and “exemplary” as used herein mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A method for producing a face shield, comprising:
cutting a body of the face shield from a flat sheet of transparent plastic;
cutting a curved attachment slot into the body;
placing the body onto a horizontally arranged elongated convex mold with a central axis of the body being aligned with a ridge line of the mold;
placing the body, on the mold, into an oven;
allowing the body to deform and assume an arcuate shape of the mold;
removing the body and the mold from the oven;
allowing the body to cool down; and
removing the body from the mold.

2. The method as in claim 1, wherein the arcuate shape of the mold is free of edges.

3. The method as in claim 1, wherein the transparent plastic is polyethylene terephthalate glycol.

4. The method as in claim 1, wherein cutting the body and cutting the curved attachment slot are performed by a laser.

5. The method as in claim 1,
wherein the oven comprises an infrared light source and
wherein allowing the body to deform is effected by activating the infrared light source.

6. The method as in claim 1,
wherein cutting the curved attachment slot into the body includes forming a plurality of narrowing protrusions within the curved attachment slot.

7. The method as in claim 6,
wherein forming the plurality of narrowing protrusions includes forming a central protrusion arranged in the central axis of the face shield, and
wherein placing the body onto the mold includes aligning the central protrusion with a ridge line marking of the mold.

8. The method as in claim 1,
wherein the mold is covered with a textile material.

9. The face shield produced by the method as in claim 1.

10. A face shield, comprising:
a body made of transparent plastic, the body having an arcuate vertical cross-sectional shape which is smooth without edges; and
a curved attachment slot for attaching the face shield to a visor of a baseball cap, the curved attachment slot having portions of constant width separated by a plurality of narrowings.

11. The face shield as in claim 10,
wherein the curved attachment slot extends vertically between an upper edge and a lower edge, and
wherein the narrowings are formed by protrusions alternatingly extending from the upper edge and the lower edge along a width of the curved attachment slot, and
wherein the protrusions have a generally triangular shape with a pointed tip arranged within the curved attachment slot.

12. The face shield as in claim 10,
wherein the narrowings have a height between 10% and 50% of the constant width.

13. The face shield as in claim 10, wherein a cross-sectional shape of the body is generally a semi-circle.

14. The face shield as in claim 10, wherein the transparent plastic is polyethylene terephthalate glycol (PETG).

15. The face shield as in claim 10, wherein the body has a height between 18 cm and 20 cm and a thickness between 0.7 mm and 1.0 mm.

16. The face shield as in claim 10, wherein the body comprises a lower symmetry mark in a central axis.
